(19) United States
(12) Patent Application Publication
(10) Pub. No.: US 2016/0291753 A1
(43) Pub. Date: Oct. 6, 2016

(54) ARRAY SUBSTRATE, TOUCH PANEL, TOUCH APPARATUS, DISPLAY PANEL AND DISPLAY APPARATUS

(71) Applicants: Shanghai Tianma Micro-Electronics Co., Ltd., Shanghai (CN); Tianma Micro-Electronics Co., Ltd., Shenzhen (CN)

(72) Inventors: Zhaokeng Cao, Shanghai (CN); Dandan Qin, Shanghai (CN)

(21) Appl. No.: 14/973,369

(22) Filed: Dec. 17, 2015

(30) Foreign Application Priority Data
Apr. 1, 2015 (CN) 201510152779.3

(51) Int. Cl. G06F 3/041

(52) U.S. Cl. CPC G06F 3/0412; G06F 3/0416

(57) ABSTRACT

An array substrate is provided. The array substrate includes a display region and a non-display region; the display region includes a first display region, a second display region, and a third display region arranged in sequence; the non-display region includes a first control module and a second control module; the display region is configured with a plurality of electrode blocks; the electrode blocks located in the first display region are connected with the first control module; the electrode blocks located in the third display region are connected with the second control module; the second display region includes at least one column of the electrode blocks, regarding each of the at least one column, some of the electrode blocks are connected with the first control module, and others are connected with the second control module. Accordingly, vision disparity can be avoided by alternately connecting the electrode blocks with different control modules.

### CROSS-REFERENCE TO RELATED APPLICATIONS

The present application claims priority to Chinese patent application No. 201510152779.3, filed with the People's Republic of China on Apr. 1, 2015, and entitled “ARRAY SUBSTRATE, TOUCH PANEL, TOUCH APPARATUS, DISPLAY PANEL AND DISPLAY APPARATUS”, the entire disclosure of which is incorporated herein by reference.

### BACKGROUND OF THE INVENTION

Liquid crystal display (LCD) devices are thin, light, power saving, radiationless, and are widely used in various electronic products, such as computers, mobile phones, and flat screen televisions. An LCD device includes a liquid crystal panel, wherein the liquid crystal panel includes an array substrate, a color film substrate, and liquid crystal encapsulated between the two substrates.

With the development of self capacitive touch display techniques, common electrodes of the array substrate in the display panel can also serve as touch detection electrodes in a self capacitive touch detecting process. Thus, through time division control, touch detecting and displaying can be implemented using different time sequences. As such, touch detection and display can be both achieved. Specifically, the common electrodes are grouped into a plurality of electrode blocks, and the plurality of electrode blocks are connected to a common drive IC (integrated circuit) through wires. During a touch detecting time cycle, a touch detection signal is provided to the electrode blocks, so as to achieve the detection function. During a display time cycle, a display drive voltage will be provided to the electrode blocks, so as to achieve the display function.

However, as dimensions of display screens are becoming larger, there are more electrode blocks configured in a display screen, and more than one drive IC is required to provide voltage signals to the electrode blocks. In practice, it has been found that, it is not easy to keep all the voltages output from the drive IC to be absolutely identical, and results in screen imperfections such as screen appearing as if it is split, which will cause poor user experience.

### SUMMARY OF THE INVENTION

The present disclosure provides an array substrate, a touch panel, a touch apparatus, a display panel, and a display apparatus, which are adapted to alleviate the vision disparity at the transition area between different display regions caused by the voltage difference as mentioned in the background.

According to one embodiment, an array substrate is provided, including: a display region and a non-display region; wherein the display region comprises a first display region, a second display region, and a third display region arranged in sequence; wherein the non-display region comprises a first control module and a second control module; wherein the display region is configured with a plurality of electrode blocks; wherein the electrode blocks located in the first display region are connected with the first control module; wherein the electrode blocks located in the third display region are connected with the second control module; and wherein the second display region includes at least one column of electrode blocks in which some of the electrode blocks are connected with the first control module, and some of electrode blocks are connected with the second control module.

According to one embodiment, a touch panel is provided, including any one of the array substrates recited above.

According to one embodiment, a touch apparatus is provided, including the touch panel recited above.

According to one embodiment, a display panel is provided, including any one of the array substrates recited above, a color film substrate, and a display cell set between the array substrate and the color film substrate.

According to one embodiment, a display apparatus is provided, including the display panel recited above.

It could be concluded that, as the first, second and third display regions are arranged in sequence, the second display region is disposed between the first and third display regions and thus can be regarded as a transition area. In the transition area, there is at least one column of electrode blocks which are respectively connected with the first control module and the second control module. It should be understood that such configuration can alleviate the vision disparity between the first and third display regions caused by the voltage difference as mentioned in the background.

Furthermore, the touch panel, the touch apparatus, the display panel, and the display apparatus provided by the present disclosure all include the array substrate recited above, thus are adapted to alleviate the vision disparity between the first and third display regions, as well.

### BRIEF DESCRIPTION OF THE DRAWINGS

FIG. 1 schematically illustrates a structure of an existing display panel.

FIG. 2 schematically illustrates a structure of an array substrate in the display panel shown in FIG. 1 according to a first embodiment of the present disclosure.

FIG. 3 schematically illustrates a structure of an array substrate according to a second embodiment of the present disclosure.

FIG. 4 schematically illustrates a structure of an array substrate according to a third embodiment of the present disclosure.

FIG. 5 schematically illustrates a structure of an array substrate according to a fourth embodiment of the present disclosure.

FIG. 6 schematically illustrates a structure of an array substrate according to a fifth embodiment of the present disclosure.

FIG. 7 schematically illustrates a structure of an array substrate according to a sixth embodiment of the present disclosure.

FIG. 8 schematically illustrates a structure of an array substrate according to a seventh embodiment of the present disclosure.

FIG. 9 schematically illustrates a structure of an array substrate according to an eighth embodiment of the present disclosure.

FIG. 10 schematically illustrates a structure of an array substrate according to a ninth embodiment of the present disclosure.

FIG. 11 schematically illustrates a structure of an array substrate according to a tenth embodiment of the present disclosure.

### DETAILED DESCRIPTION OF THE INVENTION

In order to clarify the objects, characteristics and advantages of the present disclosure, embodiments of the present disclosure will be described in detail in conjunction with the accompanying drawings. The disclosure will be described with reference to certain embodiments. Accordingly, the present disclosure is not limited to the embodiments disclosed. It will be understood by those skilled in the art that various changes may be made without departing from the spirit or scope of the disclosure.

According to the present disclosure, an array substrate is provided, which includes: a display region and a non-display region; wherein the display region comprises a first display region, a second display region, and a third display region arranged in sequence; wherein the non-display region comprises a first control module and a second control module; wherein the display region is configured with a plurality of electrode blocks; wherein the electrode blocks located in the first display region are connected with the first control module; wherein the electrode blocks located in the third display region are connected with the second control module; and wherein the second display region includes at least one column of electrode blocks in which some of the electrode blocks are connected with the first control module, and some of electrode blocks are connected with the second control module. Accordingly, in the array substrate provided by the present disclosure, electrode blocks located in a transition area of different display regions are which are respectively connected with different control modules. Thus, vision disparity on the transition area can be eliminated.

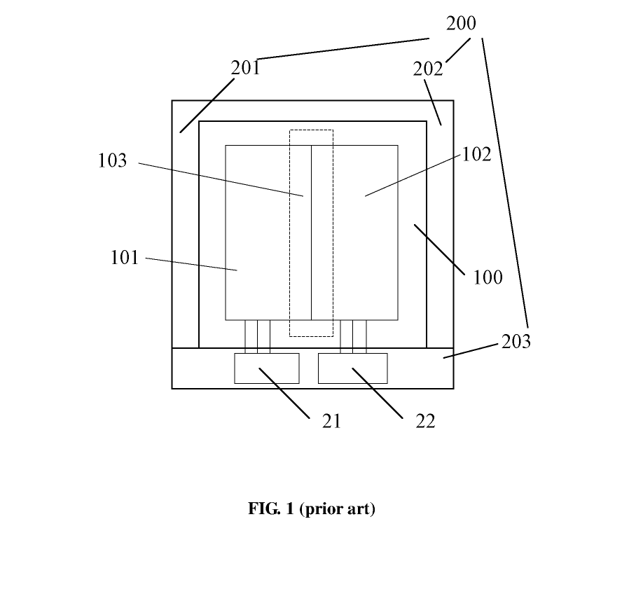

Referring to FIG. 1, an existing display panel is illustrated. The display panel includes a display region 100 and a non-display region 200. The non-display region 200 includes a first non-display region 201 located on a left side of the display region 100, a second non-display region 202 located on a right side of the display region 100, and a third non-display region 203 located below the display region 100. Furthermore, the non-display region 200 at least includes a first control module 21 and a second control module 22. It should be noted that, in FIG. 1, both the first control module 21 and the second control module 22 are located in the third non-display region 203, which is just for exemplary illustration rather than limitation. The display region 100 includes a first display region 101 where electrode blocks connected with the first control module 21 are located, and a second display region 102 where electrode blocks connected with the second control module 22 are located.

It has been found that, voltages output from the first control module 21 and the second control module 22 are unable to be exactly identical. Thus, vision disparity will occur at a transition area 103 (i.e. the dotted box) of the first display region 101 and the second display region 102. Therefore, user experience will be affected.

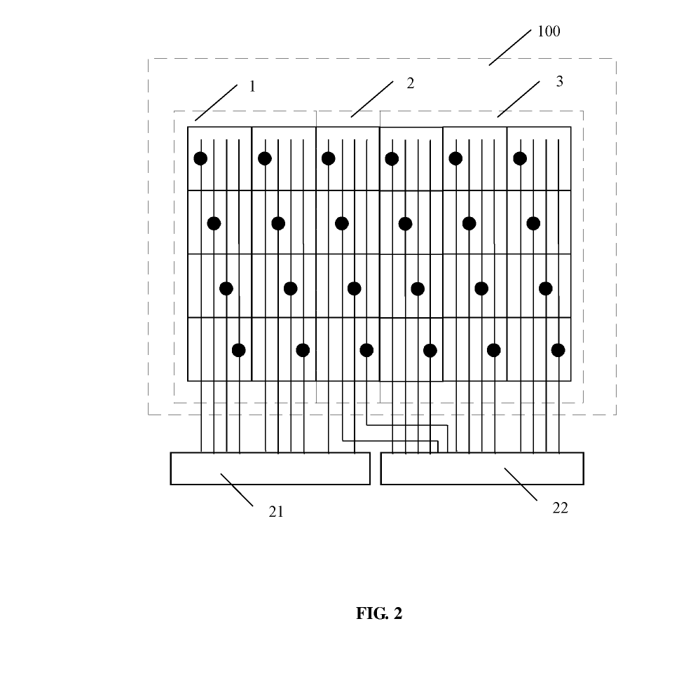

Referring to FIG. 2 in combination with FIG. 1, an array substrate according to a first embodiment of the present disclosure is illustrated, which is adapted to eliminate vision disparity at a transition area of different display regions.

The array substrate includes: a display region 100 and a non-display region 200. The non-display region 200 includes a first non-display region 201 located on a left side of the display region 100, a second non-display region 202 located on a right side of the display region 100, and a third non-display region 203 located below the display region 100. The display region 100 at least includes a first display region 1, a second display region 2, and a third display region 3 arranged in sequence. The non-display region 200 at least includes a first control module 21 and a second control module 22.

The display region 100 is configured with a plurality of electrode blocks, the electrode blocks located in the first display region 1 are all connected with the first control module 21, and the electrode blocks located in the third display region 3 are all connected with the second control module 22. The second display region 2 includes at least one column of electrode blocks in which some electrode blocks are connected with the first control module 21 and other electrode blocks are connected with the second control module 22.

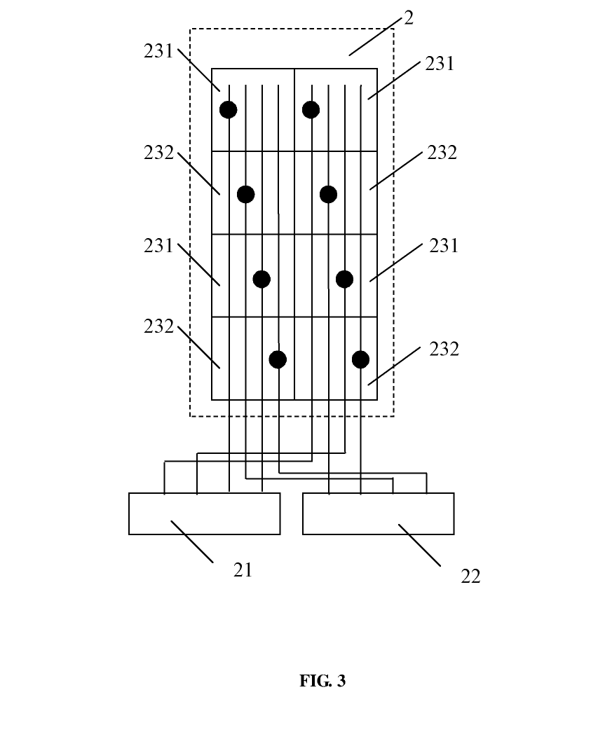

It should be noted that, in the array substrate provided by the present disclosure, the display region is divided into two sub display regions, and a transition area of the two sub display regions is defined as a second display region. Specifically, the display region is divided according to the control module with which the electrode blocks therein are connected. That is, the display region, where the electrode blocks connected with the first control module are located, is defined as the first display region; the display region, where the electrode blocks connected with the second control module are located, is defined as the third display region. In combination of FIG. 2 and FIG. 3, the number of columns of electrode blocks in the second display region is not limited. In other words, the second display region may include one column of electrode blocks as shown in FIG. 2. Or, the second display region may include two columns of electrode blocks as shown in FIG. 3. r, the second display region may include more than two columns of electrode blocks (not shown in the drawings).

When the number of the columns of electrode blocks in the second display region is an odd number, herein we take one as an example, the single one column of electrode blocks may be the one located in the display region 101 and adjacent to the display region 102, or the one located in the display region 102 and adjacent to the display region 101. When the number of the column of electrode blocks in the second display region is an even number, herein we take two as an example, as shown in FIG. 3, the two columns of electrode blocks may be the third and fourth column of electrode blocks from left to right as shown in FIG. 2.

As shown in FIG. 2, the second display region only includes one column of electrode blocks. Hereafter, we will illustrate the second region under condition of including two columns of electrode blocks, as shown in FIG. 3. Referring to FIG. 3, an array substrate according to a second embodiment of the present disclosure is illustrated. The second region includes two columns of electrode blocks, that is, a first column of electrode blocks and a second column of electrode blocks. In the first column of electrode blocks, some of the electrode blocks are connected with the first control module 21, and some of the electrode blocks are connected with the second control module 22 Similarly, in the second column of electrode blocks, some of the electrode blocks are connected with the first control module 21, and some of the electrode blocks are connected with the second control module 22.

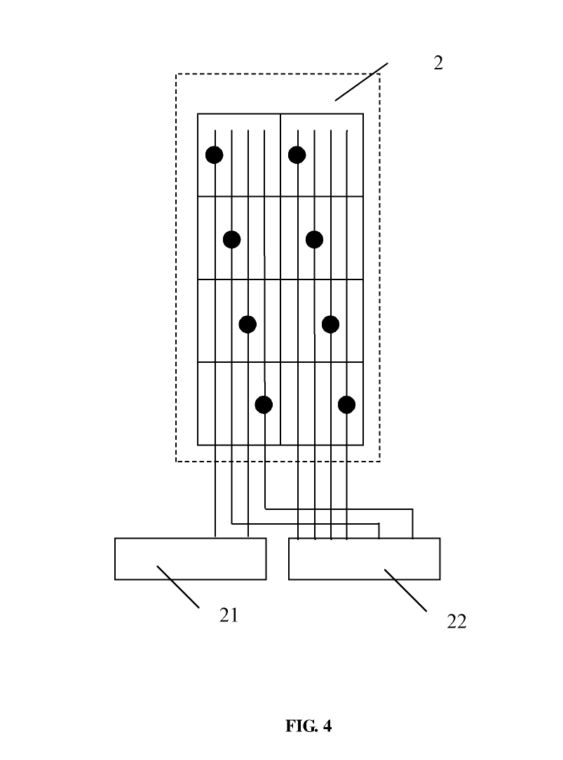

The connection configuration (i.e. the connections to the first and second control modules) can also be designed in the way as shown in FIG. 4. Referring to FIG. 4, an array substrate according to a third embodiment of the present disclosure is illustrated. Specifically, the second region includes a first column of electrode blocks which is located on a left side of the second region and a second column located of electrode blocks which is located on a right side of the second region. In the first column of electrode blocks, some of the electrode blocks are connected with the first control module 21, and some of the electrode blocks are connected with the second control module 22. In the second column of electrode blocks, all the electrode blocks are connected with the second control module 22.

Referring to FIG. 5, an array substrate according to a fourth embodiment of the present disclosure is illustrated, which is similar to the configuration of FIG. 4. Specifically, the second region includes a first column of electrode blocks which is located on a left side of the second region and a second column of electrode blocks which is located on a right side of the second region. In the second column of electrode blocks, some of the electrode blocks are connected with the first control module 21, and some of the electrode blocks are connected with the second control module 22. In the first column of electrode blocks, all the electrode blocks are connected with the first control module 21.

Furthermore, in order to solve the problem of vision disparity, arrangement of the electrode blocks in the second region is limited by the present disclosure. As shown in FIG. 3, the second display region 2 includes at least one column of electrode blocks in which some of the electrode blocks are connected with the first control module 21, and some of the electrode blocks are connected with the second control module 22. It should be noted that, in the second region 2, the electrode block connected with the first control module 21 is defined as a first electrode block 231, and the electrode block connected with the second control module 22 is defined as a second electrode block 232.

With continued reference to FIG. 3, the electrode blocks in the first column of electrode blocks from top to bottom are respectively: the first electrode block 231-the second electrode block 232-the first electrode block 231-the second electrode block 232. Similarly, the electrode blocks in the second column of electrode blocks from top to bottom are respectively: the first electrode block 231-the second electrode block 232-the first electrode block 231-the second electrode block 232. Accordingly, electrode blocks in a common column and neighboring to each other are connected with different control modules. As voltages output from different control modules are different from each other, voltages input into neighboring electrode blocks tend to be identical. Thus, display effects of neighboring electrode blocks also tend to be identical. Therefore, the vision disparity can be avoided by alternately connecting the electrode blocks with different control modules.

In some embodiments, the second display region is further limited. Specifically, any two neighboring electrode blocks in the second display region are the first electrode block and the second electrode block, respectively. For example, if the second display region includes a first column of electrode blocks and a second column of electrode blocks, the electrode blocks in the first column of electrode blocks from top to bottom are respectively: the first electrode block-the second electrode block-the first electrode block—the second electrode block. The electrode blocks in the second column of electrode blocks from top to bottom are respectively: the second electrode block-the first electrode block-the second electrode block-the first electrode block. Accordingly, any two electrode blocks neighboring to each other are connected with different control modules. As voltages output from different control modules are different from each other, voltages input into neighboring electrode blocks tend to be identical. Thus, display effects of neighboring electrode blocks also tend to be identical. Therefore, the vision disparity can be further avoided.

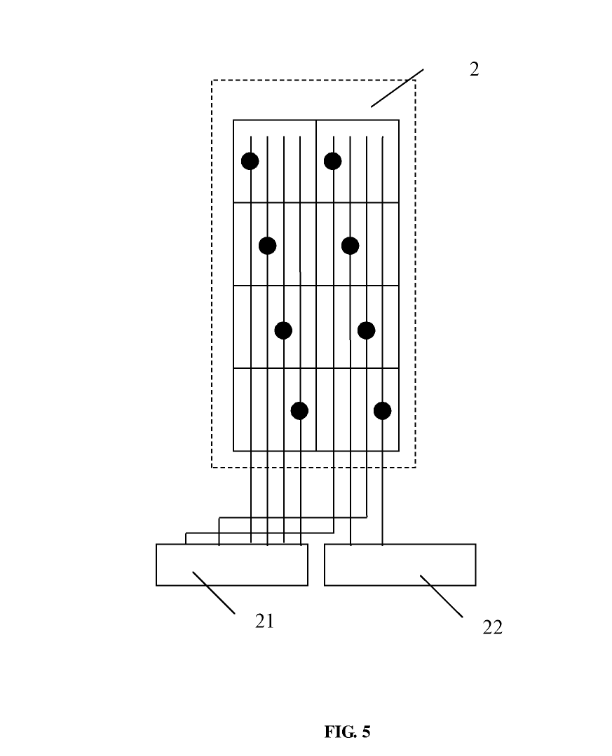

Referring to FIG. 6, an array substrate according to a fifth embodiment of the present disclosure is illustrated. The fifth embodiment also provides a wire configuration of the array substrate. Specifically, a touch sense line 31 is connected with the first control module or the second control module via a wire in the non-display region. As shown in FIG. 6, the second electrode blocks are connected with the second control module via wires located around outskirt of the display region. In this embodiment, the wires are located on the right side of the display region. In some embodiments, the wires may be located on the left side of the display region.

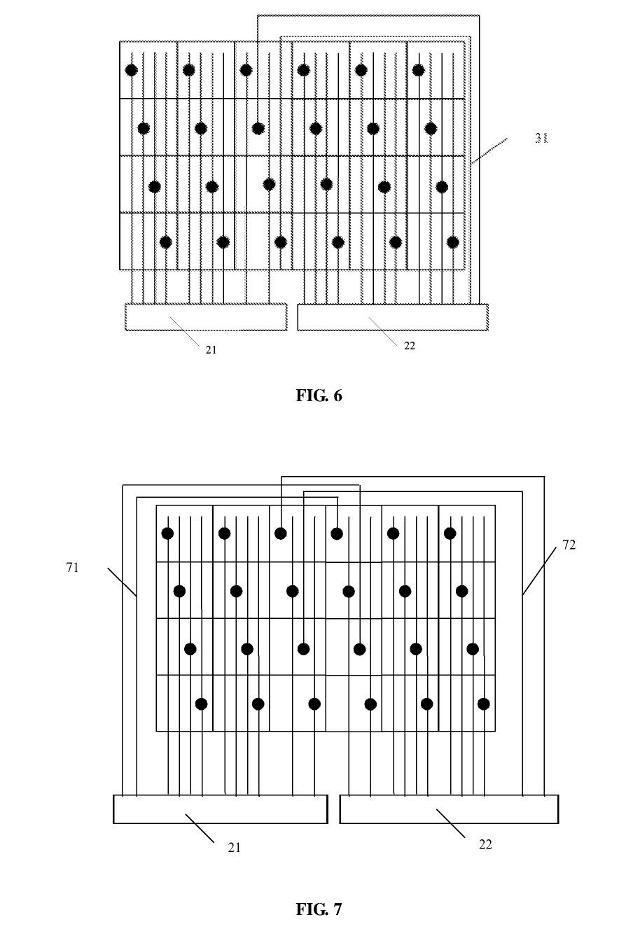

Referring to FIG. 7, an array substrate according to a sixth embodiment is illustrated. The third column and the fourth column of electrode blocks, from right to left, are defined as a second display region. Some electrode blocks in the third column are connected with the second control module 22 via wires 72 located on the right side of the display region, and some electrode blocks in the fourth column are connected with the first control module 21 via wires 71 located on the left side of the display region. It should be noted that, in the third column, the number of the electrode blocks which are connected with the second control module is not limited by the present disclosure. Similarly, in the fourth column, the number of the electrode blocks which are connected with the second control module is not limited by the present disclosure, as well.

Furthermore, the present disclosure also provides a touch panel, a touch apparatus, a display panel, and a display apparatus. The touch panel includes any one of the array substrate recited above. The touch apparatus includes the touch panel. The display panel includes a color film substrate, any one of the array substrate recited above, and display cells configured between the array substrate and the color film substrate. The display apparatus includes the display panel.

It should be noted that, the touch panel, the touch apparatus, the display panel, and the display apparatus all have the functions of the array substrate recited above.

Relation between the electrode blocks and a common electrode layer is described here within. Specifically, the common electrode layer may be for multiple use or single usage. For example, if the common electrode is only used for display control (i.e. single usage), then the common electrode layer can be configured into an entire layer structure or a structure having a hollow and continuous pattern. In this case, the common electrode layer is only used for display control, thus only electrically connected with a signal wire, wherein the signal wire is used for providing data signals to the common electrode layer, and the data signals are adapted to drive displaying.

If the common electrode layer is for multiple usages, for example, the common electrode layer is used for both display control and touch control. The common electrode layer includes: a plurality of electrode blocks; and a plurality of signal wires, wherein each of the electrode blocks is electrically connected with one of the signal wires through a via hole. When the common electrode layer is used for display control (in the display time cycle of the time sequence), each of the signal wires is used for providing data signals to the corresponding electrode block to which it is connected, and the data signals are adapted to drive displaying. When the common electrode layer is used for touch control (in the touch detection time cycle of the time sequence), each of the signal wires is used for providing data signals to the corresponding electrode block to which it connected, and the data signals are adapted to detect touching. Specifically, according to the self capacitive theory, a touch screen is configured with a plurality of self capacitive electrodes on a common layer, wherein the self capacitive electrodes are electrically isolated from each other. When there is no touch on the touch screen, capacitance on each self capacitive electrode is a fixed value; and when there is a touch on the touch screen, capacitance on the self capacitive electrode where the touch located is the fixed value plus capacitance of human body. As such, a touch position can be determined by detecting capacitance changes on the self capacitive electrodes, wherein the capacitance changes is detected by a touch detection chip. Accordingly, touch detection can be achieved.

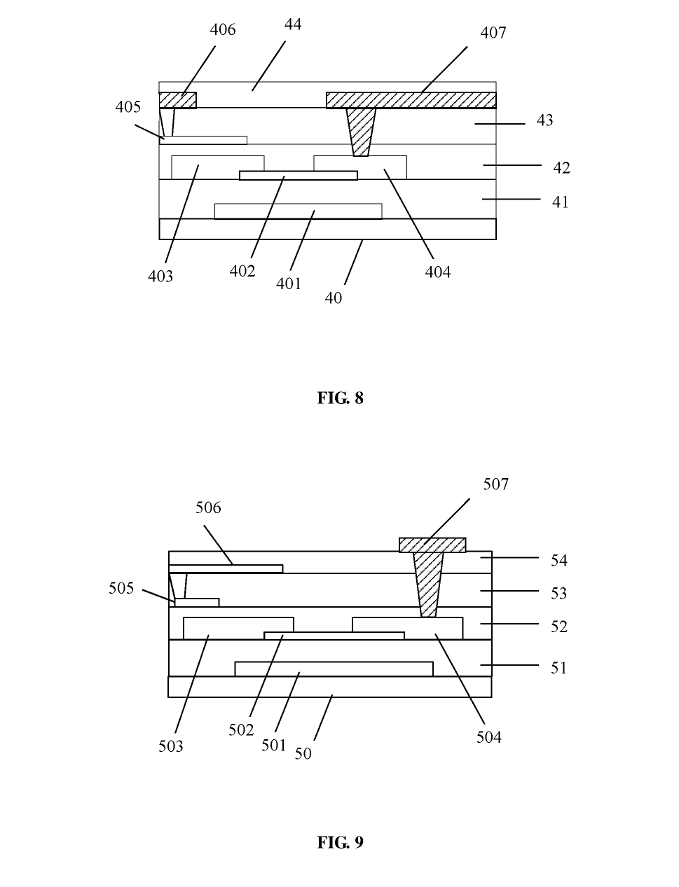

As structure of the array substrate varies, the common electrode layer can be configured into multiple patterns. Referring to FIGS. 8-10, three types of structures of the array substrate are illustrated.

Referring to FIG. 8, the array substrate is configured with a thin film transistor which is located on a substrate 40. The thin film transistor includes: a gate 401 and a gate line (not shown in FIG. 8) located on a surface of the substrate 40; a gate dielectric layer 41 overlaying the gate 401 and the gate line; a source region 402, a source 403 and a drain 404 located on the gate dielectric layer 41. A data line (not shown in FIG. 8) is connected with the source 403 and is disposed on the gate dielectric layer 41, wherein the date line and the source 403 are configured on a common layer.

In the array substrate shown in FIG. 8, the thin film transistor is set on the surface of the substrate 40. A first insulating layer 42 is set overlaying the thin film transistor. The common electrode layer 405 is set on the first insulating layer 42. A second insulating layer 43 is set overlaying the common electrode layer 405. A touch display wiring 406 and a pixel electrode 407 are set on the second insulating layer 43, wherein the pixel electrode 407 is electrically connected with the drain 404 of the thin film transistor through a via hole, and the touch display wiring 406 is electrically connected with the touch display electrode corresponding to the common electrode layer 405 through a via hole.

In the embodiment shown in FIG. 8, the touch display wiring 406 and the pixel electrode 407 are set in a common layer, thus the touch display wiring 406 and the pixel electrode 407 can be formed by one single conductive layer, which simplifies the manufacture process and reduce the manufacture cost thereof. A third insulating layer 44 is further set on the touch display wiring 406 and the pixel electrode 407. In order to prevent the touch display wiring 406 from being interfered by electromagnetic signals, the third insulating layer 44 is configured with wire shielding electrode (not shown in FIG. 8), wherein the wire shielding electrode and the touch display wiring 406 are only partially overlapped.

Referring to FIG. 9, an array substrate according to an eighth embodiment is illustrated. The array substrate is configured with a thin film transistor which is set on a substrate 50. The thin film transistor includes: a gate 501 and a gate line (not shown in FIG. 9) located on a surface of the substrate 50; a gate dielectric layer 51 overlaying the gate 501 and the gate line; a source region 502, a source 503 and a drain 504 located on the gate dielectric layer 51. A data line (not shown in FIG. 9) is connected with the source 503 is disposed on the gate dielectric layer 51, wherein the date line and the source 503 are configured on a common layer.

In the array substrate as shown in FIG. 9, the thin film transistor is set on the substrate 50; a first insulating layer 52 is set overlaying the thin film transistor; a touch display wiring 505 is set on the first insulating layer 52; a second insulating layer 53 is set overlaying the touch display wiring 505; a common electrode layer 506 is set on the second insulating layer 53; a third insulating layer 54 is set on the common electrode layer 506; a pixel electrode 507 is set on the third insulating layer 54, wherein the pixel electrode 507 is electrically connected with the drain 504 of the thin film transistor through a via hole, and the touch display wiring 505 is electrically connected with the touch display electrode corresponding to the common electrode layer 506 through a via hole.

In order to prevent the touch display wiring 505 from being interfered by electromagnetic signals, the touch display wiring 505 is configured with a wire shielding electrode (not shown in FIG. 8) thereon, wherein the wire shielding electrode and the touch display wiring 505 are only partially overlapped. Specifically, the second insulating layer 53 is configured into a two-layer structure, wherein the wire shielding electrode is set between these two layers and above the touch display wiring 505.

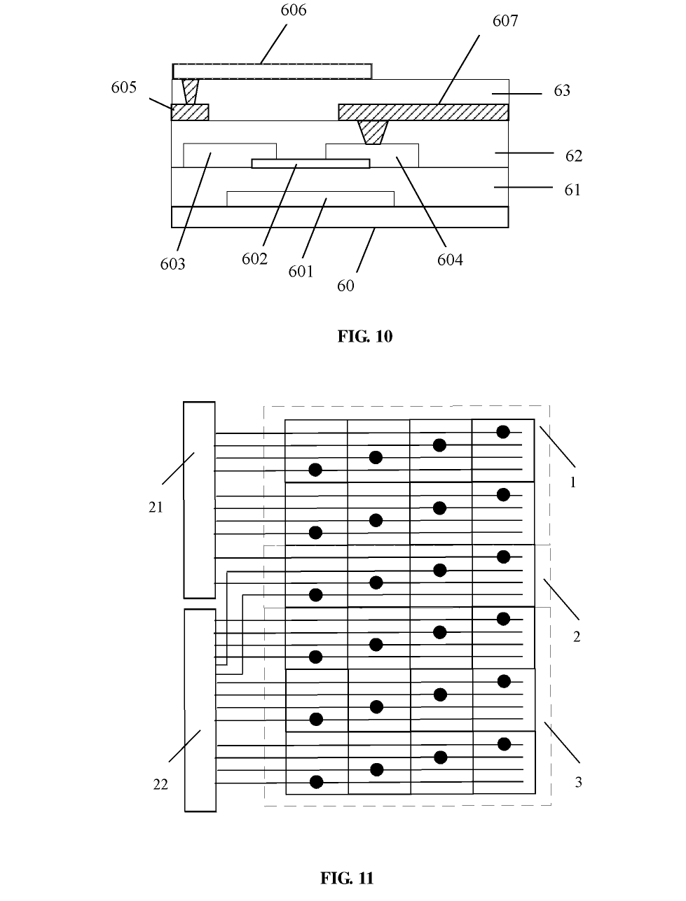

Referring to FIG. 10, an array substrate according to a ninth embodiment is illustrated. The array substrate is configured with a thin film transistor which is set on a substrate 60. The thin film transistor includes: a gate 601 and a gate line (not shown in FIG. 9) located on a surface of the substrate 60; a gate dielectric layer 61 overlaying the gate 601 and the gate line; a source region 602, a source 603 and a drain 604 located on the gate dielectric layer 61. A data line (not shown in FIG. 9) is connected with the source 603 is disposed on the gate dielectric layer 61, wherein the date line and the source 603 are configured on a common layer.

In the array substrate as shown in FIG. 10, the thin film transistor is set on the substrate 60. A first insulating layer 62 is set overlaying the thin film transistor. A touch display wiring 605 and a pixel electrode 607 are set on the first insulating layer 52, wherein the pixel electrode 607 is electrically connected with the drain 604 of the thin film transistor through a via hole. A second insulating layer 63 is set overlaying the touch display wiring 605 and the pixel electrode 607. A common electrode layer 606 is set on the second insulating layer 63.

In the embodiment as shown in FIG. 10, the touch display wiring 605 and the pixel electrode 607 are set on a common layer, and are made of a same material, thus they can be formed by one single conductive layer, which will simplify the manufacture process and reduce the manufacture cost thereof. In order to prevent the touch display wiring 605 from being interfered by electromagnetic signals, the touch display wiring 605 is configured with a wire shielding electrode (not shown in FIG. 8) thereon, wherein the wire shielding electrode and the touch display wiring 605 are only partially overlapped. Specifically, the second insulating layer 63 is configured into a two-layer structure, wherein the wire shielding electrode is set between these two layers and above the touch display wiring 605.

In some embodiments, the touch display wiring is configured to be overlapped by the data or gate line. In other words, projections of the touch display wiring and the data or gate line on the substrate are overlapped, so as to improve the aperture ratio and the light transmittance of the array substrate.

In some embodiments, the array substrate further includes a plurality of touch sense lines, wherein each electrode block is only electrically connected with one of the plurality of touch sense lines, and each electrode block is connected with corresponding control module via the touch sense lines. The control module can be a drive circuit or a shift register. The electrode blocks may have an identical shape and size, and are arranged in an array.

In the array substrate as shown in FIG. 4, the first control module 21 and the second control module 22 are set on the third non-display region 203, the first control module 21 is a first drive circuit, and the second control module 22 is a second drive circuit. Similarly, in the array substrate as shown in FIG. 11, the first control module 21 and the second control module 22 are set on the first non-display region 201. In this case, the first control module 21 is a first gate driver, and the second control module 22 is a second gate driver. Further, when the first control module 21 and the second control module 22 are set on the second non-display region 202, the first control module 21 is a first gate driver, and the second control module 22 is a second gate driver. It should be noted that, the present disclosure is not limited by the configuration as recited above, as long as some of the electrode blocks in the second display region are connected with the first gate driver, while some of the electrode blocks are connected with the second gate driver.

Accordingly, the present disclosure provides an array substrate, including: a display region and a non-display region; wherein the display region at least includes a first display region, a second display region, and a third display region which are arranged in sequence; and wherein the non-display region at least includes a first control module and a second control module. The display region is configured with a plurality of electrode blocks, the electrode blocks located in the first region are connected with the first control module, and the electrode blocks located in the third region are connected with the second control module. The second display region includes at least one column of electrode blocks in which some of the electrode blocks are connected with the first control module, and some of the electrode blocks are connected with the second control module. Accordingly, electrode blocks neighboring to each other are connected with different control modules. As voltages output from different control modules are different from each other, voltages input into neighboring electrode blocks tend to be identical. Thus, display effects of neighboring electrode blocks also tend to be identical. Therefore, the vision disparity can be alleviated by alternately connecting the electrode blocks with different control modules.

The present disclosure also provides a touch panel, a touch apparatus, a display panel, and a display apparatus, which all include the array substrate recited above, thus can alleviate the vision disparity.

Although the present disclosure has been disclosed above with reference to preferred embodiments thereof, it should be understood by those skilled in the art that various changes may be made without departing from the spirit or scope of the disclosure. Accordingly, the present disclosure is not limited to the embodiments disclosed.

What is claimed is:

1. An array substrate, comprising:
a display region, wherein the display region comprises a first display region, a second display region and a third display region arranged in sequence;
a non-display region, wherein the non-display region comprises a first control module and a second control module;
wherein the display region further comprises a plurality of electrode blocks; wherein the electrode blocks located in the first display region are connected with the first control module, and the electrode blocks located in the third display region are connected with the second control module; and
wherein the second display region comprises at least one column of electrode blocks in which at least one of the electrode blocks in the second display region is connected with the first control module, and at least one of the electrode blocks in the second display region is connected with the second control module.

2. The array substrate according to claim 1, further comprising a plurality of touch sense lines, wherein each of the plurality of electrode blocks is only electrically connected with one of the plurality of touch sense lines, and each of the plurality of electrode blocks is connected with the first control module or the second control module through the touch sense line with which it is electrically connected.

3. The array substrate according to claim 2, wherein the touch sense lines located in the second display region are connected with the first control module or the second control module through wirings configured in the non-display region.

4. The array substrate according to claim 1, wherein the first control module is a drive circuit or a gate driver.

5. The array substrate according to claim 1, wherein the second control module is a drive circuit or a gate driver.

6. The array substrate according to claim 1, wherein the at least one column of the electrode blocks in the second display region comprises first electrode blocks and second electrode blocks;
the first electrode blocks and the second electrode blocks in a common column are alternately arranged; and the first electrode blocks are connected with the first control module, the second electrode blocks are connected with the second control module.

7. The array substrate according to claim 6, wherein in the second display region, any two of the electrode blocks neighboring to each other are respectively the first electrode block and the second electrode block.

8. The array substrate according to claim 1, wherein the plurality of electrode blocks has identical shape and dimension, and is arranged in an array.

9. A touch panel, comprising an array substrate, wherein the array substrate comprises:
a display region, wherein the display region comprises a first display region, a second display region and a third display region arranged in sequence;
and a non-display region, wherein the non-display region comprises a first control module and a second control module;
wherein the display region further comprises a plurality of electrode blocks, wherein the electrode blocks located in the first display region are connected with the first control module, and the electrode blocks located in the third display region are connected with the second control module; and
wherein the second display region comprises at least one column of electrode blocks in which at least one of the electrode blocks in the second display region is connected with the first control module, and at least one of the electrode blocks in the second display region is connected with the second control module.

10. A touch apparatus, comprising the touch panel according to claim 9.

11. A display panel, comprising an array substrate, a color film substrate, and a display cell set between the array substrate and the color film substrate, wherein the array substrate comprises:
a display region and a non-display region;
wherein the display region comprises a first display region, a second display region and a third display region arranged in sequence;
wherein the non-display region comprises a first control module and a second control module;
wherein the display region further comprises a plurality of electrode blocks, wherein the electrode blocks located in the first display region are connected with the first control module, and the electrode blocks located in the third display region are connected with the second control module; and
wherein the second display region comprises at least one column of electrode blocks in which at least one of the electrode blocks in the second display region is connected with the first control module, and at least one of the electrode blocks in the second display region is connected with the second control module.

12. A display apparatus, comprising the display panel according to claim 11.
